(19) United States
(12) Patent Application Publication
(10) Pub. No.: US 2006/0259338 A1
(43) Pub. Date: Nov. 16, 2006

(54) System and method to improve operational status indication and performance based outcomes

(75) Inventors: Rodney Rodrigue, Augusta, ME (US); Claudia Follet, Merritt Island, FL (US); Harvey B. Powell, Trinity, FL (US); Peter Weymouth, Scarborough, ME (US)

Correspondence Address: CHRIS A. CASEIRO, VERRILL DANA, LLP, ONE PORTLAND SQUARE, PORTLAND, ME, 04112-0586, US

(73) Assignee: Time Wise Solutions, LLC, Augusta, ME (US)

(21) Appl. No.: 11/127,412

(22) Filed: May 12, 2005

(51) Int. Cl. G06F 9/44

(52) U.S. Cl. 705/7

(57) ABSTRACT

A system and related method to assist a business in evaluating the rapid response to one or more product fabrication bid requests. The system includes a survey function for gathering information from individuals of identified groups. The information includes assigned values associated with a plurality of defined outcomes. The system also includes a calculation function to calculate opportunity scores associated with the values obtained for the outcomes through the survey function. A reporting function of the system applies the calculated opportunity scores to a visual representation, such as an innovation dashboard, of those outcomes that may be modified with the best chance of producing a positive effect on the status of the business. An optional function of the system is a planning function including worksheets to define steps to undertake to produce the improvements in the identified outcomes. The related method includes the steps of conducting the survey, obtaining normalized outcome rating and ranking values, optionally weighting those values by surveyed group, and calculating opportunity scores for each outcome. The method further includes the steps of reporting the calculated opportunity scores and by time weighted outcome groups and thereby identifying areas of the business to be improved with measurable impact.

### BACKGROUND OF THE INVENTION

1. Field of the Invention

The present invention relates to systems and methods designed to assist businesses organize their resources and develop plans to conduct their operations based on desired outcomes. More particularly, the present invention relates to systems and methods to produce a “dashboard” representative of business objectives and capabilities, and arranged to produce resource planning options based on desired outcome alternatives.

2. Description of the Prior Art

Many businesses tend to evaluate their status based on current conditions. Any business has a particular set of parameters that it monitors to determine current status. Examples include research expenditures, marketing expenditures, capital investment, manhours required to produce a product, supply inventory level, product inventory level, sales figures, gross margins, and net income, to name just a few. The focus of analysis tends to be on the current financial status, in particular, in determining whether the business is in good health. Generally, if it is determined that the company is meeting its current desired financial targets (e.g., sales and net income) then the operational functions (e.g., manhours per product and marketing budget) employed to generate those financial parameters are considered to be correct. The business then continues its operation as-is based on that assumption, and may even expand its operations. On the other hand, if the financial parameters of interest are deemed not to have been met, then action is often taken to revise operations. For example, employment levels may be reduced, research curtailed, or capital upgrades postponed.

As indicated, business status measurement systems are built from the bottom up based on indicators of what the business is currently engaged in doing. This focuses the management team on answering the question, “Are we doing things right?”, based on the tendency to over-balance its evaluation of business health toward financials. However, those metrics lag behind current operational activities, creating ongoing reactive course correction in operations responsive to currently perceived financial variants. In effect, the tail wags the dog.

There has been one substantial change to the rote process business status evaluation described above. An evaluation system originated by Norton and Kaplan provides a means by which organizations may evaluate performance based not solely on financial criteria, but on other measures, including manufacturing, delivery, and quality characteristics, for example. The Norton and Kaplan system, referred to as the “balanced scorecard,” suggests a more balanced view for measurement of business functions, in which the organization's strategy forms the basis for measurement, rather than solely or primarily the financial condition. In effect, the process associated with the creation of the balanced scorecard suggests that businesses first answer the question, “Are we doing the right things?” and then address the question, “Are we doing things right?” This change in view has spurred a look, for those businesses adopting this process, to consider the functional operations with at least the same importance as is assigned to the financial conditions when evaluating the status of the business.

The balanced scorecard is a good starting point to assist a business in evaluating its status as a means to plot a course to success; however, it does not go far enough in providing that assistance. The balanced scorecard is designed to be created based on the views of the groups associated with the business, i.e., the shareholders, the customers, the employees, and the internal management. That is, the impact of business decisions made on the different groups is made part of the evaluation rather than solely the shareholders, for example. Unfortunately, this form of evaluation is more subjective than objective. As a result, the personal biases of those entering information deemed relevant into the system, and those viewing the information, weighs on the outcome of the evaluation.

The subjective nature of the Norton and Kaplan balanced scorecard system requires very specific tailoring of the underlying database to ensure that the information relevant to the identified groups is applicable to a specific business. It would be preferable to have a status indication system, embodied in the form of a scorecard, dashboard, or other format with which business managers are comfortable, that may be standardized, account for relevant metrics, and do so in a way that recognizes the importance of each evaluation parameter on the entirety of the business. While it may be generally known that each business action taken, or event occurring, has a time element associated with it, current status indication systems do not take the time element into account in an appropriate manner. They may identify time frames associated with actions and events, but fail to correlate that with other actions or events. That is, current status indication systems disclose what has been done, what is being done, and current financial status. What current status systems fail to account for is the time relationship associated with parameters and future outcomes. What is needed is a system that provides business management with the capability to properly weight parameters in relation to their present and future impact on present and future outcomes.

In addition to the deficiencies in current status indication systems described above, there is a missing tool that would be of benefit to businesses having the scorecard information before them. Specifically, the status indication information, which may be presented in a scorecard, dashboard, or other equivalent format, only provides management with an indication of state based on management's perception of what is important and should be modified. The status indication systems available fail to provide management with the option to incorporate the perceptions of others related to the business in a manner that properly ranks and rates those perceptions. For example, it would be of use to business management to weigh the potential impact on total sales by increasing the marketing budget by some percentage, to observe the potential outcome on gross margins by increasing capital expenditure on a particular type of equipment, or to observe the potential outcome on net income by shifting to a different accounting format. Currently, businesses often perform such evaluations by trial-and-error. That is, they make an adjustment to some operational activity in reality, and then await the outcome of the change on a selected parameter of interest. Such a method of evaluation may or may not produce the desired outcome at an unknown point in the future, and may modify other unselected parameters in an unexpected manner. Such uncertainty is generally not desirable in business.

Therefore, what is needed is a system and related method to assist businesses in determining their operational status in a way that includes a time weighting for each identified parameter. Specifically, the time weighting must reflect the impact of a particular activity, event, or outcome on the business. Further, what is needed is such a system and related method to properly time-weight each activity, event, or outcome that optionally includes a mechanism for the business to take into account in a quantifiable manner the relative importance of the various parameters relevant to the business, and observe the impact of adjustments made to one or more parameters. Such a system and related method would enhance the accuracy of the representation of the status of the business and would assist management in identifying causes and effects mathematically rather than through actual trial-and-error.

### SUMMARY OF THE INVENTION

It is an object of the present invention to provide a system and related method to assist businesses in determining their operational status in a way that includes a time weighting for each identified parameter. That is, it is an object of the invention to associate some form of time indicator with each activity, event, or outcome deemed relevant to the business. It is also an object of the present invention to provide such a system and related method to include, in addition to the time-weighting, a mechanism for the business to account for the importance of various business-related parameters in a quantifiable manner. Such a system and related method would enhance the accuracy of the representation of the status of the business and would assist management in identifying causes and effects mathematically rather than through actual trial-and-error, and to arrange for adjustments as needed in an organized manner.

These and other objects are achieved with the present invention. The present invention has added more rigor to the business status measurement system and more predictability to the tactical planning process. The system and related method improves upon the initial advances associated with the Norton and Kaplan process by incorporating an understanding of the predictive relationships among the business metrics. Specifically, each metric (or measure or parameter) is divided among a plurality of categories having a time element associated therewith. For example, in the preferred embodiment of the invention there are four time-related categories: far lagging, lagging, leading, and far leading. The present invention provides a metrics tree constructed to enable visualization of the relationship between each measure, including based on the time weighting attributed to the respective categories. The system allows the business manager to take proactive steps based on predictive measures, rather than waiting for a lagging indicator to signal trouble. Example measures of relevant parameters or measures and their recommended time-weighting category include: Financial Strategic—Far Lagging (furthest back in time), Customer—Lagging (next furthest in time), Process—Leading (at the point of the here and now), and Innovation and Resource—farthest Leading (to be done in advance). Other examples and details of these relationships will be described herein.

In addition to providing the time-weighting relationship, the system and method of the present invention provide the business manager with another optional capability. Specifically, the system includes a statistical tool used for tactical planning. An opportunity rating for each desired outcome is fed into a matrix analysis. The analysis examines the relationship between all designated outcomes and prioritizes the predictive metrics to yield one or more of those outcomes. This capability allows the manager to drive several positive outcomes with a single tactical plan but prevents negative unanticipated impacts in complex systems. That is, all outcomes of interest may be considered, given selectable ratings, and the parameter conditions required to produce such outcome(s) are generated.

It is to be noted that while each specific business may have particular outcomes of interest, it appears that there are approximately 134 business outcome variants that would comprise the interest of substantially all businesses. The system of the present invention may be configured to allow for tactical planning with respect to all 134 outcomes in a standardized tool that may be made available to all potential users. Each business is then permitted to select from the range of options those one or more outcomes of interest, rate them as desired, and see the measures or parameters required to produce such outcomes. The tool may be embodied in one or more computer programs, one or more appliances, or a combination of software and hardware.

The present invention is a system and related method to assist businesses in obtaining reasonably accurate information regarding the status of operations based on time-weighting of operational measures. The invention further includes an optional planning tool to correlate that information with desired outcomes and adjust operations to produce the desired outcomes. These and other advantages of the present invention will become apparent upon review of the following detailed description, the attached drawings, and the appended claims.

### BRIEF DESCRIPTION OF THE DRAWINGS

FIG. 1 is a block diagram of the functional elements of the system of the present invention.

FIG. 2 is a simplified diagrammatic representation of an example computing system including the bid response system of the present invention.

FIG. 3 is a simplified flow diagram representing the primary steps of the method of the present invention.

FIG. 4 is a representation of an example Relationship Matrix, showing the Opportunity scores of selected Outcomes and the impact on other Outcomes through improvement of one or more of the Outcomes.

FIG. 5 is a representation of an example of an Innovation Dashboard of the present invention.

FIG. 6 is a graphical representation of the interrelationship among four sets of Outcomes based on their respective time components.

FIG. 7 is a first example worksheet for improvement planning and evaluation of a set of Far Lagging Outcomes.

FIG. 8 is a second example worksheet for improvement planning and evaluation of a set of Lagging Outcomes.

FIG. 9 is a third example worksheet for improvement planning and evaluation of a set of Leading Outcomes.

FIG. 10 is a fourth example worksheet for improvement planning and evaluation of a set of Far Leading Outcomes.

FIG. 11 is an example representation of a Kaizen team composition chart that may be used as part of the step of implementing improvement goals.

FIG. 12 is an example representation of a Kaizen mandate checklist that may be used as part of the step of implementing improvement goals.

### DETAILED DESCRIPTION OF THE PREFERRED EMBODIMENT

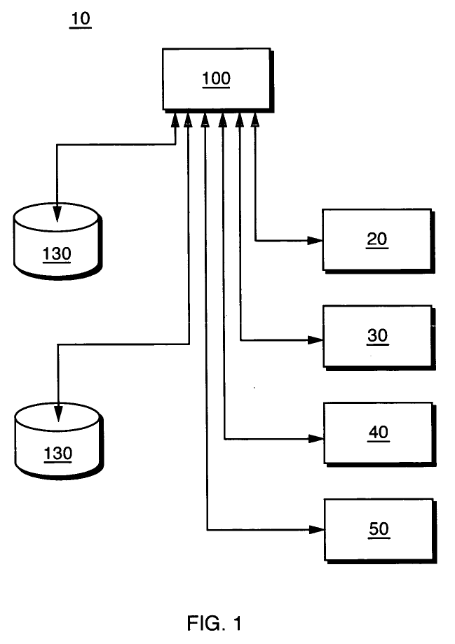

As represented in FIG. 1, the present invention is a business status indication and improvement planning system 10 and related method to enable manufacturers, particularly SME manufacturers but not limited thereto, to obtain a quantifiable indication of the state of the business, where weaknesses may exist, the time relationship among various actions and events of the business, and the ability to target improvements. The system 10 includes a survey function 20, a calculation function 30, a reporting function 40, and a planning function 50. A computer system 100 is preferably used as the means by which the functions described, along with one or more databases 130, to store and query information. The survey function 20 is configured to generate Outcome identifications, lists of groups and individuals associated with the Outcomes, and queries to make to the identified groups in accordance with the method of the present invention. The calculation function 30 is configured to calculate an Opportunity score based on Importance and Satisfaction ratings, as described herein, agreed upon in a consensus established by the members of the groups. The calculation is based on a formula that may be generated and used, or acquired and used, which formula allows the Outcomes to be ranked by relative value to the organization.

The reporting function 40 is configured to generate a listing of the results of the survey, including a listing in order of importance for the business of those outcomes considered to be most relevant to the business's success. The listing also preferably includes a normalization of the results and the extent of the importance of each outcome for each of the identified groups. The reporting function 40 further provides a dashboard representation of the outcomes considered to be most important, as well as a time component associated with each set of outcomes grouped by time relevance to the business. That is, one or more sets of one or more outcomes are grouped and displayed based upon their time impact. I.e., whether, if they are modified, they will have an immediate or future impact on the status of the business. The planning function 50, which may be an optional function, produces one or more worksheets setting out for the business the identified important outcomes, grouped by time component, and steps to undertake to improve the calculated values associated therewith. While the reporting function 40 provides the business with a picture of the status in a quantified by normalized values, and grouped by time function, it does not provide the business with the tools to make improvements to the reported scores. The planning function 50 provides that capability by focusing the business on those identified outcomes of importance with measurable plans and steps for improvement. One or more of the identified functions may be established as discrete components, or parts of one or more common components. They may be coupled together as module components in any combination of hardware, firmware, software, microcode, manually performed, or any combination thereof.

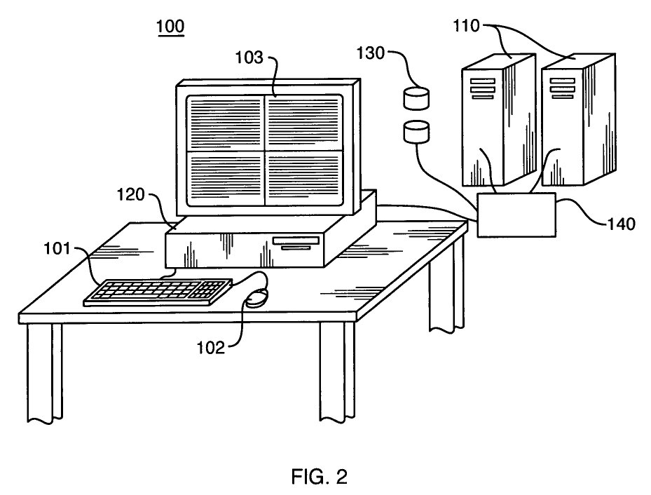

As illustrated in FIG. 2, a user of the system 10 may engage in a status evaluation and planning effort through the computer system 100 that may be associated with local or remote computing means, such as one or more central computers, such as server 110 in a local area network, a metropolitan area network, a wide area network, or through intranet and internet connections. The computer system 100 may include one or more discrete computer processor devices, represented by desktop computer 120, for example. The computer system 100 may include computer devices operated by the business (i.e, desktop, laptop, or servers), and/or one or more providers of services to assist in the reporting and planning methods. The server 110, the computer processor 120, or a combination of both may be programmed to include one or more of the functions of the system 10. One or more databases represented by database 130 that may be associated with the server 110, the computer processor 120, other computing devices, or any combination thereof, include information related to the use of the system 10. For example, the database 130 may include information regarding customers, employees, managers, outcome options, and planning options, for example. The database 130 may be populated and updated with information provided by an application provider capable of carrying out one or more of the steps associated with the system 10, one or more businesses, or any other information providers. All of the devices may be interconnected through one or more signal exchange devices, such as router/switch 140.

In operation, a user of the system 10 inputs status- or survey-related information through one or more input devices, such as a keyboard 101, a mouse 102, or a combination thereof, as well as any other input means suitable for directing information and requests to the server 110 and/or the processor 120. The input information, queries, and output information may be viewed on a computer display 103. Optionally, a local or remote printer 104 may be employed to print out input information, query information, and/or output information. For purposes of this description, query information may include, but not be limited to, questions regarding groups, outcomes, reports, and plans to be embodied in worksheets. Output information may include, but not be limited to, dashboards, metric trees, and worksheets. It is to be noted that the system may be accessed and used through other forms of hardware devices including, for example, text/graphic scanner or reader inputs, touch-screen technology, voice recognition/synthesis equipment, other input/output devices, portable laptop, notebook, in-vehicle, or handheld personal digital assistant (PDA) portable computer devices, including those equipped for wireless communications, and telephony devices, such as wireless phones and IP-based phones. In one embodiment of the invention, an application specific program available through the Maine Manufacturing Extension Partnership of Augusta, Me., and identified by the trademark TimeWise™ Lean Solution may be employed as the computing system to perform the functions of the system 10 regarding data collection and analysis. It is to be understood that other data collection and analysis systems may be employed for the same purpose. The present invention relates to the data to be collected, any weighting to be applied thereto, and the selection of responsive steps based upon the analysis.

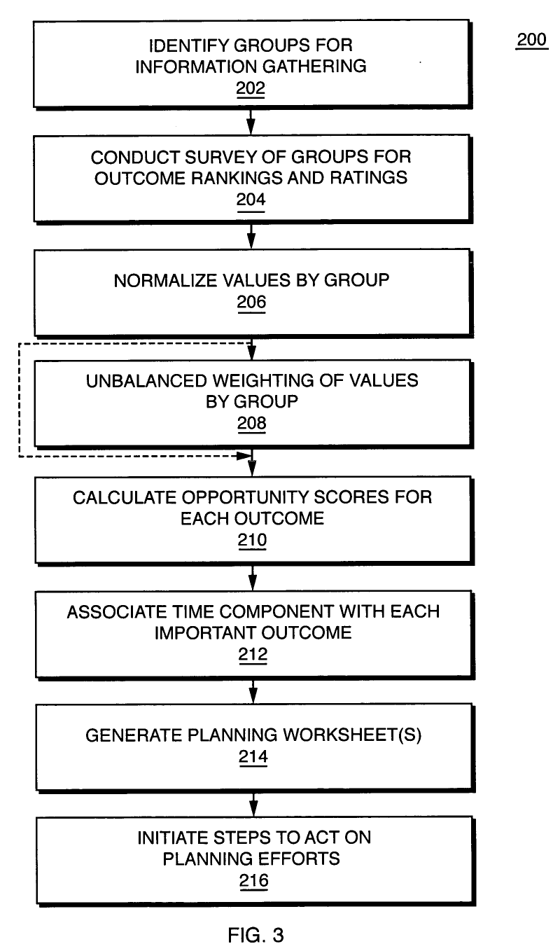

As illustrated in FIG. 3, a method 200 of the present invention embodied in the system 10, or other system with equivalent functionality, aids businesses in determining the status of business functions, and their effects on one another, includes a plurality of steps. It is to be understood that the steps described herein may be carried out through the identified functions of the system 10 as electronic functions performed through the computer system 100 based on computer programming steps. The functions configured to perform the steps described herein may be implemented in hardware and/or software. For example, particular software, firmware, or microcode functions executing on the computing devices can provide the survey function 20, the calculation function 30, the reporting function 40, and the optional planning function 50. Alternatively, or in addition, hardware modules, such as programmable arrays, can be used in the devices to provide some or all of those functions, provided they are programmed to perform the steps described.

The method 200 includes the step of identifying one or more groups of people having some association with the business for the purpose of gathering information considered relevant to the business (step 202) associated with the survey function 20. The information to be gathered is described in terms of identifiable, understandable, and measurable Outcomes. The Outcomes are specific activities, events, actions, results, or the like, that may be of importance to any of the groups. In general, the groups of interest include business customers, business strategists, business operations personnel, and business financial personnel. However, it is to be understood that more or fewer groups, or different groups, may form the basis of the survey to be conducted to gather the information.

It has been determined that there are 134 Outcomes that are of importance in some portion for most any group that may be associated with most any business. Table 1 lists the 134 Outcomes. It is to be understood that the 134 Outcomes listed in Table 1 may be re-written using different words; however, the basic focus of each of the listed Outcomes is substantially standardized for any business.

TABLE 1

| Number | Outcome |
|---|---|
| 1 | Minimize the percent of delivered items that do not meet |
| | the customer's stated specifications |
| 2 | Increase the percent of orders that are received on time |
| | by the customer |
| 3 | Minimize the time it takes to respond to a special |
| | customer request |
| 4 | Minimize the time it takes the company to determine which |
| | alternative product and service concepts should be developed |
| 5 | Minimize the price that is charged for items that are |
| | ordered by the customer |
| 6 | Minimize the time it takes the customer to modify an order |
| | that has already been placed |
| 7 | Increase the amount of value that is delivered to the |
| | company's external customers |
| 8 | Increase the percent of customer delivery processes that |
| | are optimized to deliver the company the desired result |
| 9 | Increase the percent of internal support processes that |
| | are optimized to deliver the company the desired result |
| 10 | Minimize the time it takes the customer to receive an |
| | item once it has been ordered |
| 11 | Increase the amount of cash the company has in reserve |
| 12 | Minimize the time it takes the company employees to |
| | determine what actions they should take to deliver the |
| | most value |
| 13 | Minimize the time it takes the customer to obtain |
| | information that is requested |
| 14 | Increase the number of competencies that are possessed |
| | by the company |
| 15 | Increase the percent of company decisions that are |
| | optimized for the creation of value |
| 16 | Increase the percent of potential customers that have |
| | access to the company's products and services |
| 17 | Minimize the company's cost of creating the offerings |
| | that are required to sustain a market position |
| 18 | Minimize the number of under performing organizations on |
| | which the company must depend |
| 19 | Minimize the time it takes the customer to resolve a |
| | problem/issue |
| 20 | Minimize the number of plans that are implemented by the |
| | company before it is known how much value they will create |
| 21 | Minimize the time it takes the company to move information |
| | to those who need it |
| 22 | Increase the percent of parts and supplies that are |
| | available to the company when needed |
| 23 | Increase the length of time the customer is given to react |
| | to an order that cannot be delivered on time |
| 24 | Increase the percent of company employees who have the |
| | skills required to execute their assignments |
| 25 | Minimize the time it takes a company employee to process |
| | the information that is required to make a decision |
| 26 | Minimize the time it takes the customer to make ongoing |
| | design improvements to the items being supplied |
| 27 | Minimize the company's cost of labor |
| 28 | Increase the percent of customers who perceive the company |
| | the way it wants to be perceived |
| 29 | Increase the company's profit margin |
| 30 | Increase the length of time over which the company's |
| | desired employees are retained |
| 31 | Minimize the time it takes the company to incorporate |
| | changes into its infrastructure |
| 32 | Minimize the time it takes the company to gain regulatory |
| | approvals |
| 33 | Minimize the time it takes the customer to design a |
| | part/supply that can be produced |
| 34 | Minimize the time it takes the customer to determine that |
| | the offering cannot be acquired somewhere else for less money |
| 35 | Increase the percent of potential customers who are aware |
| | of the company and its products |
| 36 | Increase the amount of time the customer is allowed to |
| | pay for items that are ordered |
| 37 | Minimize the company's cost of raw material spoilage |
| | or waste |
| 38 | Minimize the number of company processes that have an |
| | unacceptable amount of variability |
| 39 | Increase the amount of value that is delivered to the |
| | company's internal customers |
| 40 | Minimize the time it takes the customer to return unwanted |
| | items |
| 41 | Minimize the percent of company decisions that are based |
| | on inaccurate or incomplete information |
| 42 | Increase the company's percent growth in revenue |
| 43 | Minimize the company's investment in fixed costs |
| 44 | Minimize the unit cost of the company's products and |
| | services |
| 45 | Minimize the company's cost of distribution |
| 46 | Increase the company's market share |
| 47 | Minimize the number of company processes in which an |
| | unacceptable amount of variability is introduced |
| 48 | Minimize the amount of time that company employees spend |
| | correcting problems that were caused by the execution of |
| | misguided actions |
| 49 | Minimize the time it takes the customer to design an item |
| | that satisfies the stated requirements |
| 50 | Increase the percent of plans the company generates that |
| | are optimized for the creation of value |
| 51 | Minimize the number of competitors over which the company |
| | does not enjoy a competitive advantage |
| 52 | Increase the percent of qualified potential customers that |
| | are identified by the company |
| 53 | Increase the percent of employees that are committed to the |
| | company's plans and strategies |
| 54 | Minimize the time it takes a company employee to obtain the |
| | information that is required to make a decision |
| 55 | Minimize the company's cost of raw materials |
| 56 | Minimize the company's cost of service |
| 57 | Minimize the amount of time the customer must spend moving |
| | items to where they are needed |
| 58 | Minimize the customer's cost of recycling |
| 59 | Minimize the customer's cost of removing packaging |
| 60 | Minimize the customer's cost of training employees to |
| | support the finished product |
| 61 | Minimize the number of times inaccurate information is |
| | received by a customer |
| 62 | Increase the percent of incremental revenue that is |
| | retained by the company after the strategy is implemented |
| 63 | Minimize the company's cost of generating demand for |
| | its offerings |
| 64 | Increase the company's level of employee satisfaction |
| 65 | Minimize the company's cost of marketing communications |
| 66 | Minimize the company's risk that results from |
| | fluctuations in the value of currency |
| 67 | Minimize the time it takes the customer to receive a |
| | prototype |
| 68 | Minimize the time it takes to deliver an emergency order |
| | to the customer |
| 69 | Minimize the time it takes the customer to receive a |
| | credit for returned items |
| 70 | Minimize the number of substitute products that are a |
| | threat to the company's current offerings |
| 71 | Minimize the company's cost of overcoming regulatory |
| | restrictions |
| 72 | Minimize the time it takes to get the company's |
| | products and services to market |
| 73 | Minimize the time it takes a company employee to respond |
| | to requests made by other employees/functions |
| 74 | Minimize the time it takes the company to uncover the |
| | solution that will deliver the most value to a given situation |
| 75 | Minimize the amount of existing company revenue that is |
| | cannibalized |
| 76 | Minimize the incremental fee that is charged to fill an |
| | emergency order for the customer |
| 77 | Minimize the customer's cost of transportation/shipping |
| 78 | Minimize the customer's cost or repairing field failures |
| | that are caused by items obtained from the company |
| 79 | Minimize the time it takes the customer to receive |
| | technical support |
| 80 | Minimize the time it takes the customer to receive a |
| | request for a quote |
| 81 | Minimize the company's cost of potential legal liabilities |
| 82 | Minimize the company's overall cost of executing the |
| | strategy |
| 83 | Minimize the number of key parts, supplies and |
| | technologies that are available to the company's |
| | competitors |
| 84 | Minimize the percent of company employees who use |
| | different sets of facts as their basis for decision making |
| 85 | Minimize the time it takes the company to uncover a |
| | variance that has been introduced into a process |
| 86 | Minimize the number of other customers who are obtaining |
| | the same items at a lower price |
| 87 | Minimize the time it takes the customer to determine that |
| | the available offerings are better than those found elsewhere |
| 88 | Minimize the company's inventory carrying costs |
| 89 | Minimize the company's variable costs |
| 90 | Minimize the time it takes the customer to set up for |
| | production |
| 91 | Minimize the customer's cost of reworking items that |
| | are delivered |
| 92 | Minimize time it takes the company to fight off competitive |
| | responses to its actions |
| 93 | Minimize the number of unfavorable constraints that are |
| | imposed on the company |
| 94 | Minimize the number of company business partners that are |
| | hurt financially as a result of executing strategy |
| 95 | Minimize the company's cost of customer retention |
| 96 | Minimize the company's cost of fending off competitive |
| | responses to its chosen strategy |
| 97 | Minimize the time it takes the customer to place an order |
| 98 | Minimize the customer's manufacturing cycle time |
| 99 | Minimize the amount of floor space that is required by the |
| | customer |
| 100 | Minimize the percent of customers who are switching to |
| | competitors' products |
| 101 | Increase the company's upside revenue potential |
| 102 | Minimize the company's selling or sales costs |
| 103 | Minimize the company's cost of exiting strategy |
| 104 | Minimize the time it takes the customer to negotiate the |
| | price of an item |
| 105 | Increase the growth phase of the company's current |
| | product life cycles |
| 106 | Minimize the time it takes the company to obtain the |
| | operating efficiencies that are required to achieve |
| | profitability |
| 107 | Increase the price that can be charged for the company's |
| | products and services |
| 108 | Minimize the percent of company employees that resist change |
| 109 | Minimize the number of changes the company makes to a |
| | product or service concept once its development has begun |
| 110 | Minimize the number of potential competitors that find it |
| | attractive to enter the company's markets |
| 111 | Minimize the customer's cost of scrap |
| 112 | Minimize the time it takes the company to break even on |
| | the costs associated with executing the strategy |
| 113 | Minimize the number of company employees that are assigned |
| | to develop products and services that will eventually fail |
| 114 | Increase the percent of company employees that are operating |
| | at the desired level of productivity |
| 115 | Minimize the percent of assignments that are repeated |
| | unnecessarily by employees around the company |
| 116 | Increase the percent of internal support processes that are |
| | executed by the company to the desired level of efficiency |
| 117 | Increase the percent of customer delivery processes that |
| | are executed by the company to the desired level of efficiency |
| 118 | Minimize the time it takes the company to return a process |
| | to a stable state once a variance has been detected |
| 119 | Minimize the time it takes the customer to schedule |
| | production runs |
| 120 | Minimize the amount of excess capacity that exists in the |
| | company |
| 121 | Minimize the amount of time that company employees spend |
| | on activities that do not create value |
| 122 | Minimize the customer's cost of inventory |
| 123 | Minimize the amount of company money that is placed at risk |
| 124 | Minimize the amount of time the customer spends correcting |
| | problems that were caused by the supplier |
| 125 | Increase the company's percent growth in profitability |
| 126 | Minimize the customer's production down time |
| 127 | Increase the percent of internal support processes that |
| | are executed by the company within the desired cycle time |
| 128 | Increase the percent of customer delivery processes that |
| | are executed by the company within the desired cycle time |
| 129 | Minimize the customer's product development cycle time |
| 130 | Increase the percent of time that the company's |
| | resources are allocated to generate the most value |
| 131 | Minimize the customer's cost of labor |
| 132 | Minimize the time it takes the company to implement a |
| | valued solution |
| 133 | Minimize the amount of market share that can be gained by |
| | each competitor of the company |
| 134 | Increase the market value of the company's stock |

With continuing reference to FIG. 3, each member of the groups surveyed is requested to assign specific values to each of the listed Outcomes (step 204) through the survey function 20, which may be a manual or electronic query. Each individual assigns both an Importance value and a Satisfaction value using a five-point Likert scale. An importance rating of five indicates that the individual feels the particular Outcome is critical to the company., However, if the Outcome is rated as a one, that indicates that that particular Outcome is not important at all. Next, each participant rates the same Outcomes for current level of satisfaction. Again, a five-point Likert scale is used. A rating of five indicates completely satisfied, while a rating of one indicates not satisfied at all.

The raw numbers obtained from the survey of each group are normalized with respect to each specific group to establish a single Importance number and a single Satisfaction number for each Outcome for each group (step 206) through a consensus process. However, it is to be understood that a particular organization may use an alternative method for normalizing the numbers, including through direct mathematical averaging, for example. This consensus process begins with the outlier in the group (i.e., the individual or set of individuals who assign an Importance value and/or a Satisfaction value that is substantially different from the numbers assigned by others of the group) presenting a business case for the rating given for the particular Outcome under consideration. Discussion ensues and consensus is reached on a single rating first for Importance and then for Satisfaction. Optionally, prior to discussion of customer Outcomes, external customer research may be presented for consideration that may further influence the group's thinking of values to be assigned.

With continuing reference to FIG. 3, the next step in the method 200 of the present invention is to calculate an Opportunity score with each of the Outcomes for which ratings have been obtained (step 210), again through the calculation function 30. The mechanism for arriving at the Opportunity score is Opportunity=Importance+(Importance−Satisfaction). It is to be noted that the particular organization may wish to establish a different formula for calculating the Opportunity score such as, for example, weighting satisfaction more heavily. For the preferred equation shown, as an example, a particular Outcome having a normalized Importance value of 4.5 (very important on a 1-5 scale) and a Satisfaction value of 1.5 (not too satisfied on the 1-5 scale), would produce an Opportunity score of 7.5 using this equation. As a second example, a normalized Importance value of 2.0 (of modest importance on a 1-5 scale) and a Satisfaction value of 3.0 (quite satisfied on the 1-5 scale), would produce an Opportunity score of 1.0 using this equation. The calculations may be performed electronically (or manually if desired) and the information preferably stored in the database 130.

The Opportunity score established for each of the Outcomes provides the business with a quantified indication of those specific Outcomes, which, if focused upon by the business, may yield improvements in the overall status of the business. For the two example Opportunity scores indicated above represent, for the 7.5 score, room for improvement with respect to the Outcome associated therewith, and for the 1.0 score, an Outcome that may not need or require adjustment. Specifically, the 7.5 score represents an important Outcome for which satisfaction is low. For the 1.0 score, the Outcome is of low importance and, in any case, there is satisfaction with its status. The next step for the business is to associate a time component with each of the Outcomes (step 212). While the business may associate a time component with each of the Outcomes, it is reasonable to focus on a portion of the Outcomes.

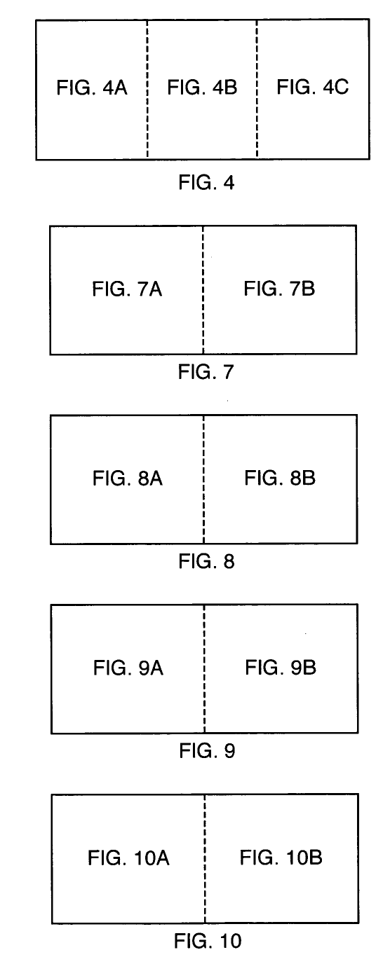

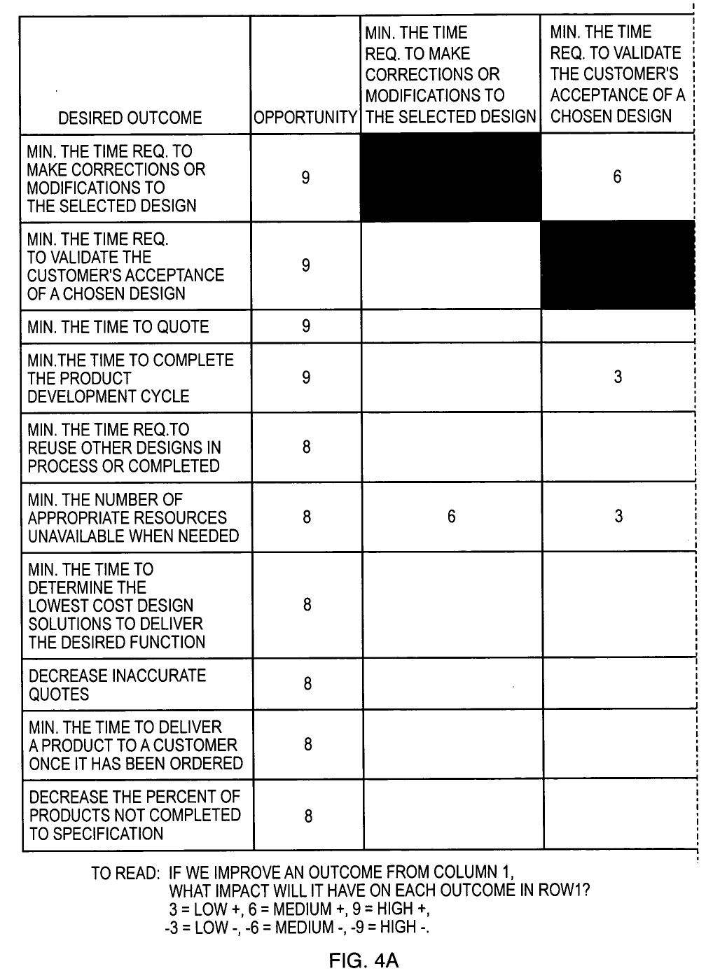

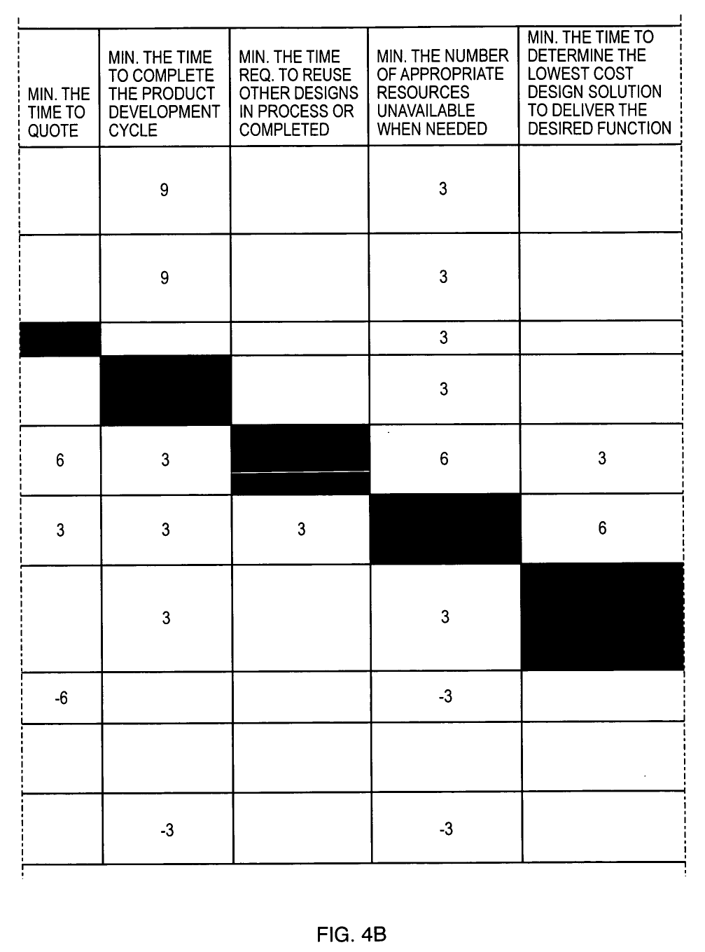

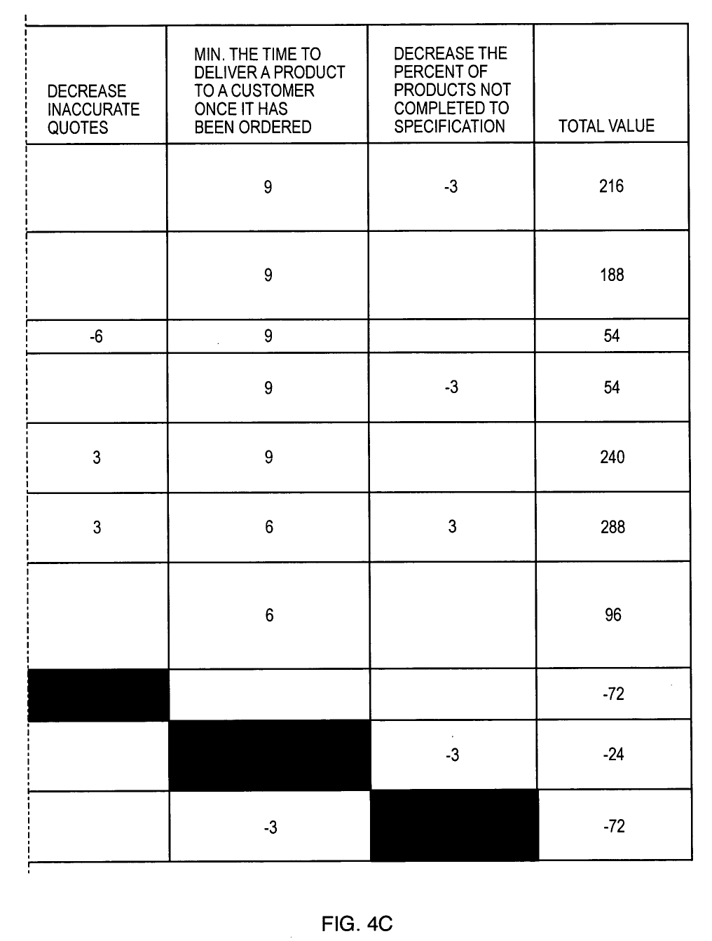

Preferably, the Outcomes receiving the most attention should be those having the highest Opportunity scores. Alternatively, or in combination, it may be the Outcomes with the highest Importance values, the lowest Satisfaction values, or any selectable combination of all three. Typically, for the equation above, a business would only turn its attention to an Opportunity with a score of 8.0 or above, although that would be up to the business to decide ultimately the threshold score to be established. In a preferred embodiment of the invention, Outcomes with Opportunity scores of 8 or greater are downloaded into a relationship matrix. One example of a relationship matrix is shown in FIG. 4. Each of ten Outcomes having Opportunity scores of 8.0 are higher are presented. The impact of modifying one or more of those high-rated Outcomes may be examined through the relationship matrix for its leverage (improvement impact) or conflict (decline impact) with all other high-rated Outcomes.

Impact values, positive and negative, may be assigned to those Outcomes affecting others of the high-rated Outcomes. For example, positive impacts may be categorized as low (value =+3), medium (value =+6), and high (value =+9), and negative impacts may be categorized as low (value=−3), medium (value=−6), and high (value=−9). A high positive impact value means that improving the particular Outcome will have a strong positive affect on another Outcome, while a high negative impact value means that improving the particular Outcome will have a strong adverse affect on another Outcome. FIG. 4 provides examples of impact values associated with particular Outcomes. The last column of FIG. 4 includes the Total Value of the impact of improving each of the Outcomes. The Total Value is the Opportunity score multiplied by the sum of the individual impact values. Those Outcomes with the greatest relative leverage should provide the greatest net impact and should be most often chosen for improvement efforts. For instance, the Outcome, “Minimize the time required to make corrections or modifications to the selected design” will probably strongly positively leverage the Outcome, “Minimize the time to complete the product development cycle.” Alternatively, the Outcome “Decrease inaccurate quotes” will probably substantially negatively leverage the Outcome “Minimize the time to quote.” Those Outcomes that indicate conflict with other Outcomes, such as the quote Outcome, should receive further review before being chosen for improvement action. Moreover, those Outcomes with the highest Total Values may be selected for improvement efforts, based on their high Opportunity scores and positive impacts on other Outcomes. Again with reference to FIG. 4, it appears that greatest leverage and improvement would be achieved through improvement of the “Minimize the number of appropriate resources unavailable when needed” Outcome, even though it has an Opportunity score of 8.0 rather than 9.0, due to its overall positive impact scores and, therefore, minimal negative impact with respect to all of the other Outcomes. On the other hand, efforts to improve the “Decrease the percent of products not completed to specification” Outcome may be minimized. Those Outcomes suitable for selection for improvement targeting may be chosen by leadership consensus or by a standardized or customized formula.

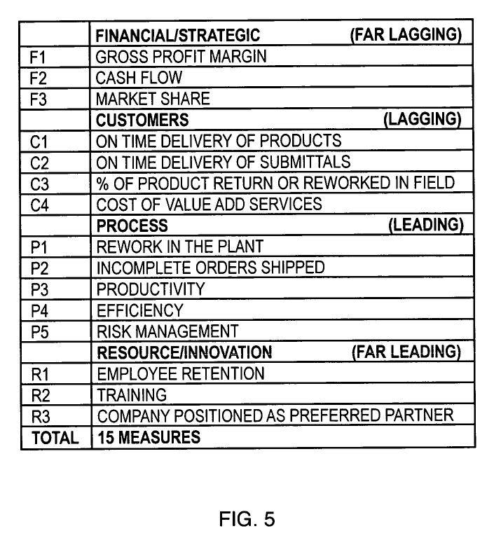

The user of the system 10 and related method 200 of the present invention may generate, or have generated through the reporting function 40, an Innovation Dashboard, showing a selected set of Outcomes determined by the Opportunity scoring to be most likely to produce positive results if modified. The selected Outcomes are grouped together by the groups defined and surveyed in the course of the information gathering performed in step 202. The Innovation Dashboard further assigns a time component to each group. An example of an Innovation Dashboard showing a selected set of Outcomes grouped together and assigned time components is presented in FIG. 5. In the example of FIG. 5, the four groups are: 1) Financial/Strategic (internal financial management), 2) Customers, 3) Process (internal operations), and 4) Resource/Innovation (internal strategic and research management). The Outcomes of focus in the example are: 1) gross profit margin, cash flow, and market share (Financial/Strategic), 2) on-time delivery of products, on-time delivery of submittals (e.g., bid responses), percentage of product returned or repaired in the field, and cost of value-added services (Customer), 3) rework in the plant, incomplete orders shipped, productivity, efficiency, and risk management (Process), and 4) employee retention, training, and preferred supplier positioning (Resource/Innovation).

The Innovation Dashboard further includes an indication of the time component for each of the identified groups. Specifically in FIG. 5, they are: 1) Financial/Strategic is Far Lagging, 2) Customer is Lagging, 3) Process is Leading, and 4) Resource/Innovation is Far Leading. A set of Outcomes defined as Far Lagging represent conditions, events, occurrences actions, that are impacted by all other Outcomes occurring prior to that particular set of Outcomes. A set of Outcomes defined as Lagging represent conditions, events, occurrences actions, that are impacted by all Leading and Far Leading Outcomes, and impacting upon the Far Lagging Outcomes. A set of Outcomes defined as Leading represent conditions, events, occurrences actions, that are impacted by the Far Leading Outcomes, and that impact upon the Far Lagging and Lagging Outcomes. Finally, a set of Outcomes defined as Far Leading impact upon all other Outcomes. As an example in consideration of FIG. 5, by training an employee to operate a more efficient piece of equipment (Far Leading), the business may increase the efficiency of fabrication of a product critical to a customer's business (Leading), thereby ensuring more certainty to the customer of on-time delivery to the customer's satisfaction (Lagging), and the customer may be willing to pay immediately for that certainty, thereby improving the business's cash flow (Far Lagging).

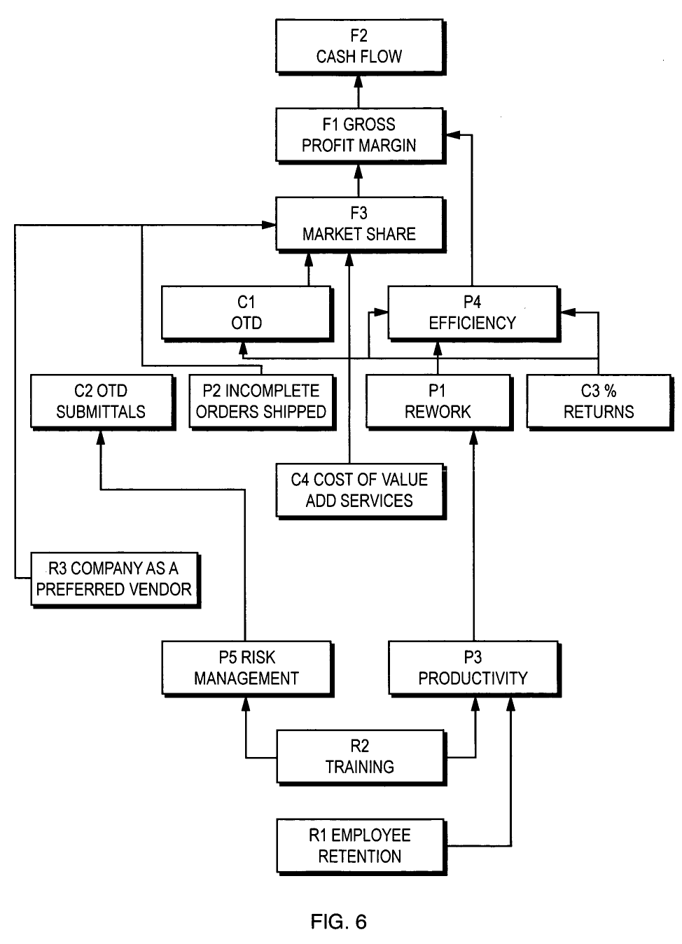

A metrics tree such as that shown in FIG. 6, created through the reporting function 40, illustrates the interrelationships among the different Outcomes represented on the Innovation Dashboard of FIG. 5. It can be seen that the Leading and Far Leading Outcomes feed into the Lagging and Far Lagging Outcomes, either directly or indirectly. This simplified representation of the interrelationships among the Outcomes groups provides a clear indication of the way in which modification of the Leading and Far Leading Outcomes affect the other Outcomes. Further, the relationship matrix of FIG. 4, which provides an indication of the leverage (positive) and conflict (negative) effects that selected Outcomes with relatively high Opportunity scores have on one another, may be viewed in combination with the metrics tree of FIG. 6 to provide a further comprehensive representation of the interactions of the selected Outcomes and their time dependencies. This combined view provides the management of an organization with a high-level indication of where resources should be directed to produce the most effective positive effects on the status of the organization.

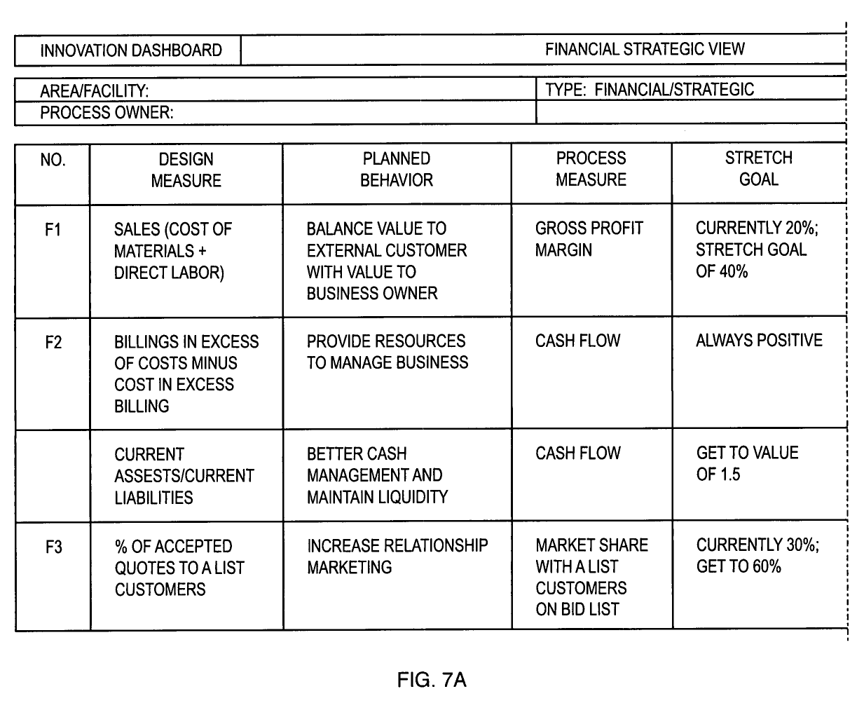

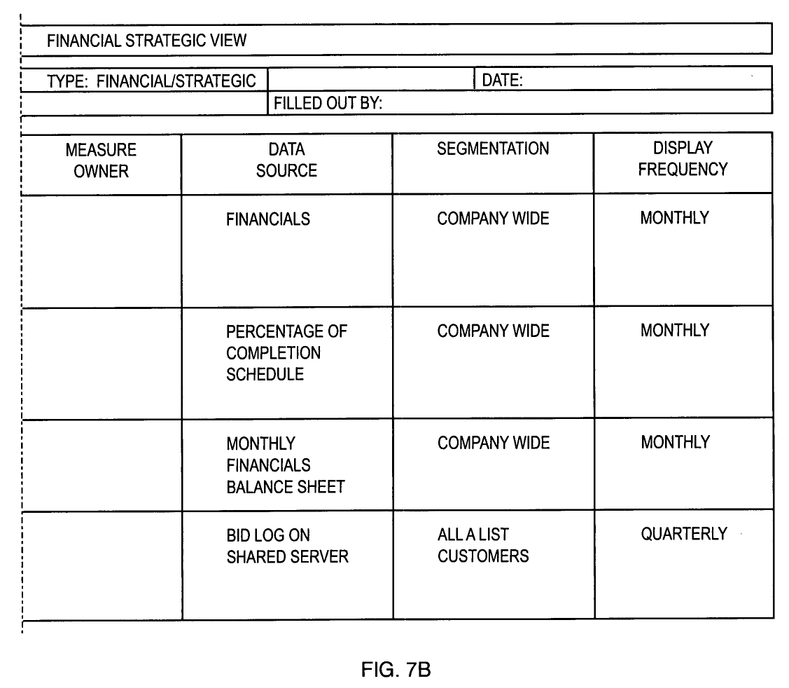

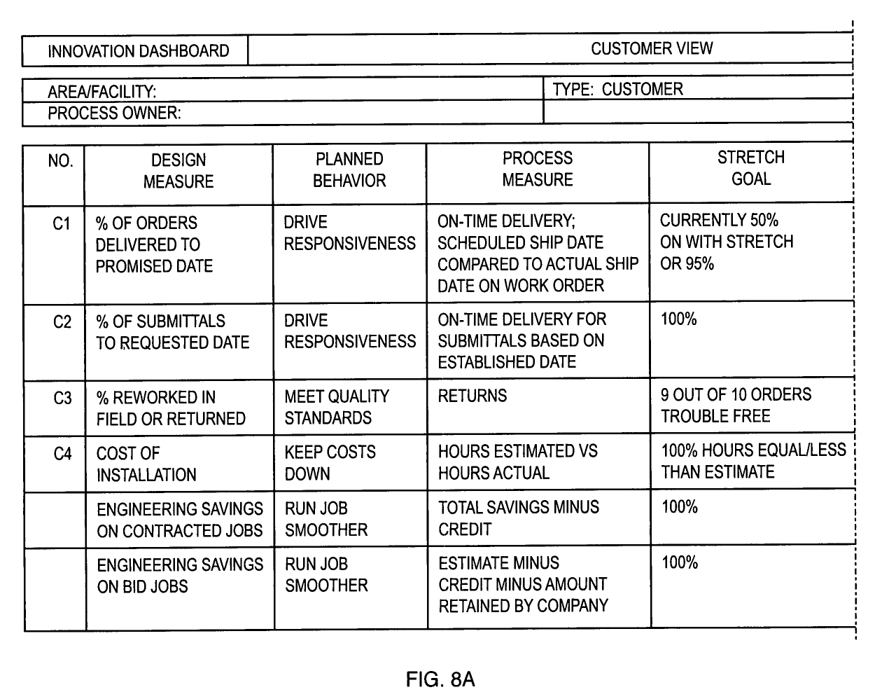

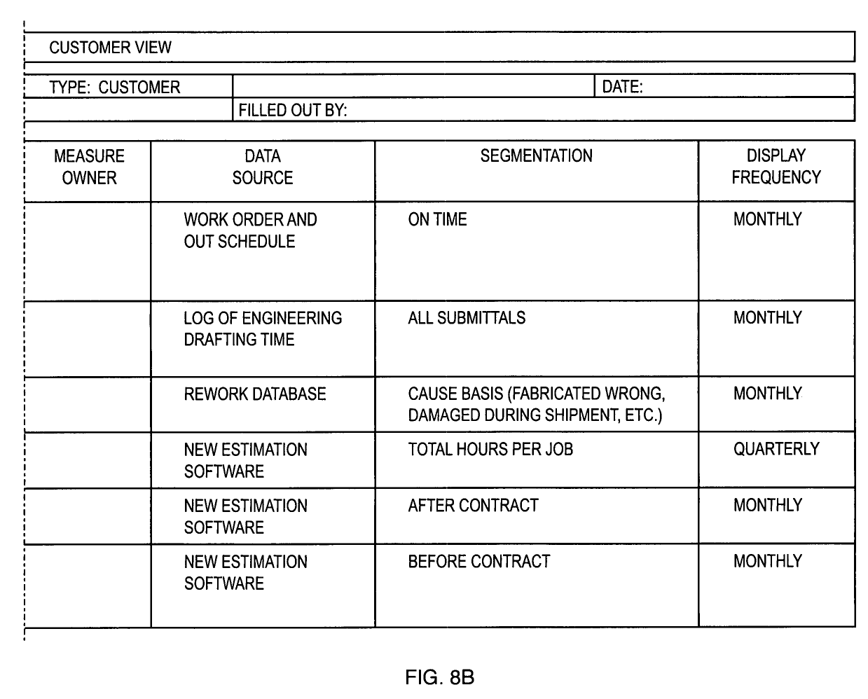

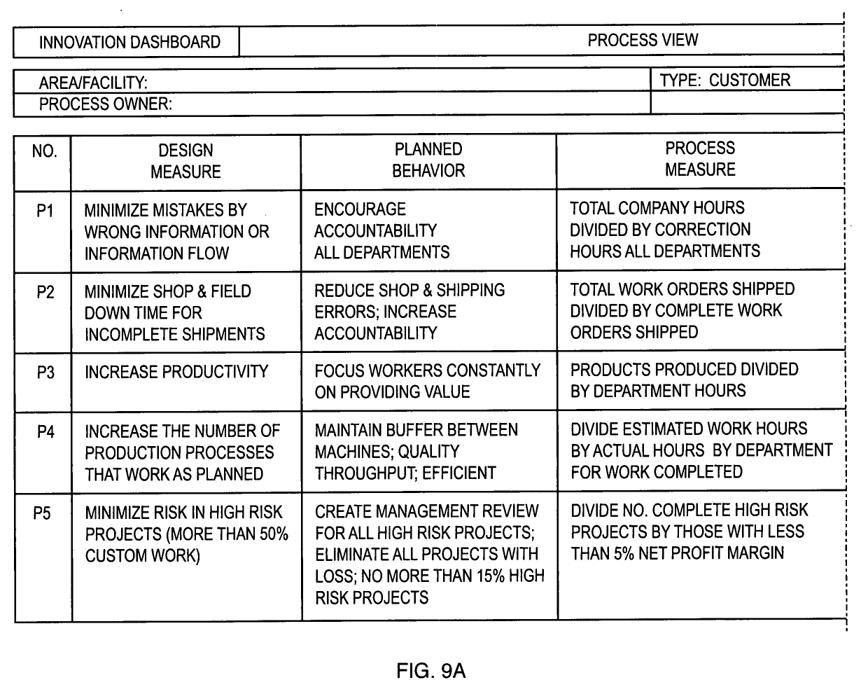

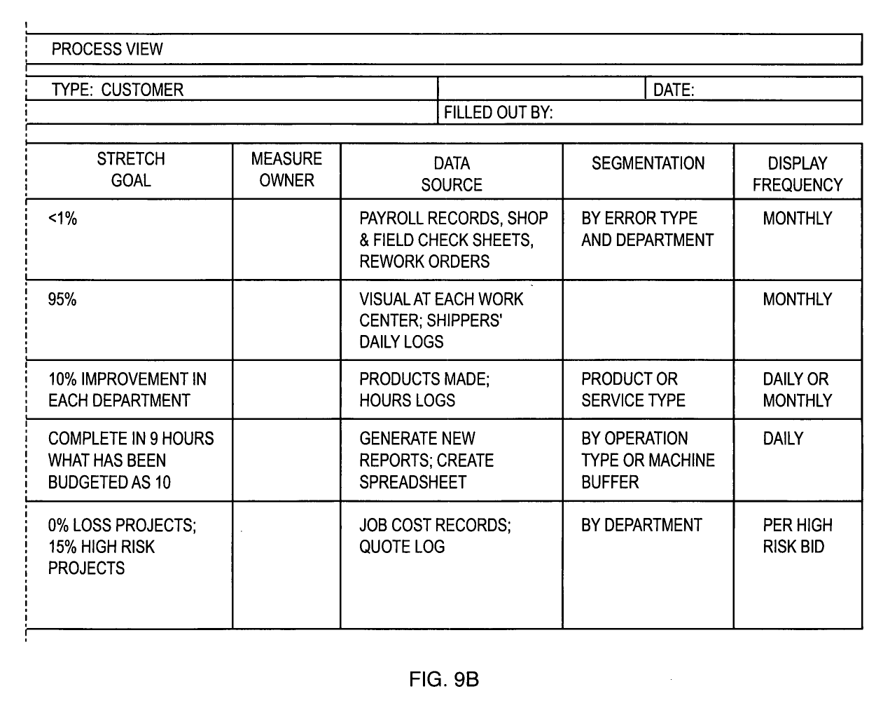

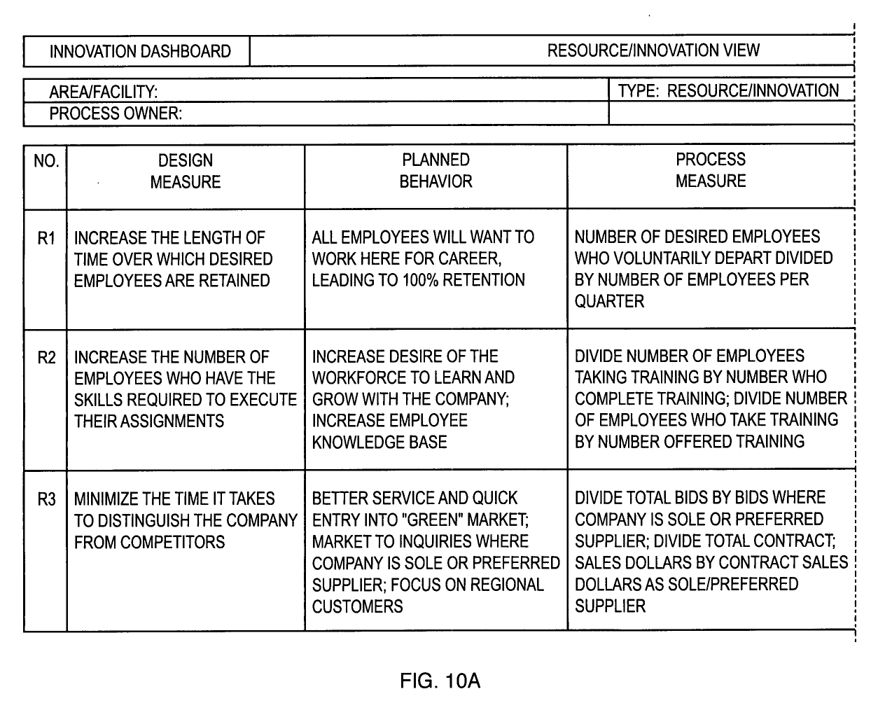

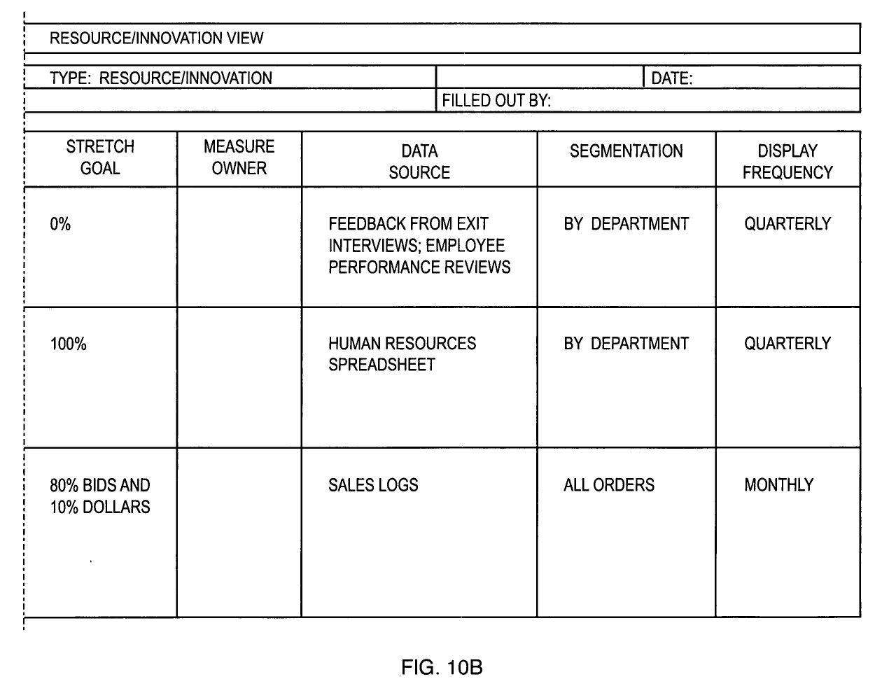

The Innovation Dashboard of FIG. 5, or its equivalent generated based upon the Opportunity scoring, may be used by a business to focus its attention on the Outcomes that are most relevant to it and that are most likely to affect in a positive way the status of the business. Returning to FIG. 3, the next step in the method 200 is an optional step associated with the planning function 50, in which business management may generate one or more worksheets providing specific steps for establishing goals to improve on defined Outcomes (step 214). Example worksheets are shown in FIGS. 7-10, representing the fifteen Outcomes of FIG. 5 in the defined groups. Each worksheet identifies the particular Outcome to be focused on, the planned behavior associated with affecting that Outcome, the metric(s) used to quantify whether the planned behavior is productive, the “stretch goal,” which to the goal to be reached for that Outcome, the individual(s) responsible for tracking the planned behavior, the source of information for the metric(s), the area of the business or industry of relevance to the Outcome, and the schedule for updating the status of the efforts associated with modifying the particular Outcome. Of course, each business may have its own particular set of Outcomes to be made the focus of efforts of improvement. The example worksheets of FIGS. 7-10 are meant to be illustrative only. All planning information and worksheet outputs may be stored in the database 130.

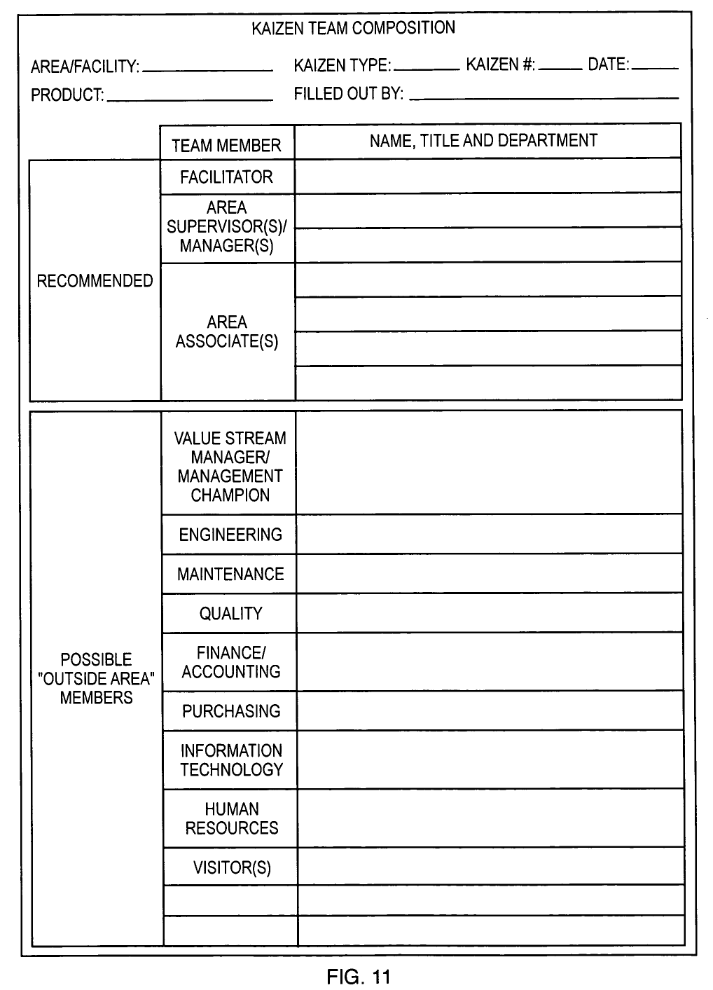

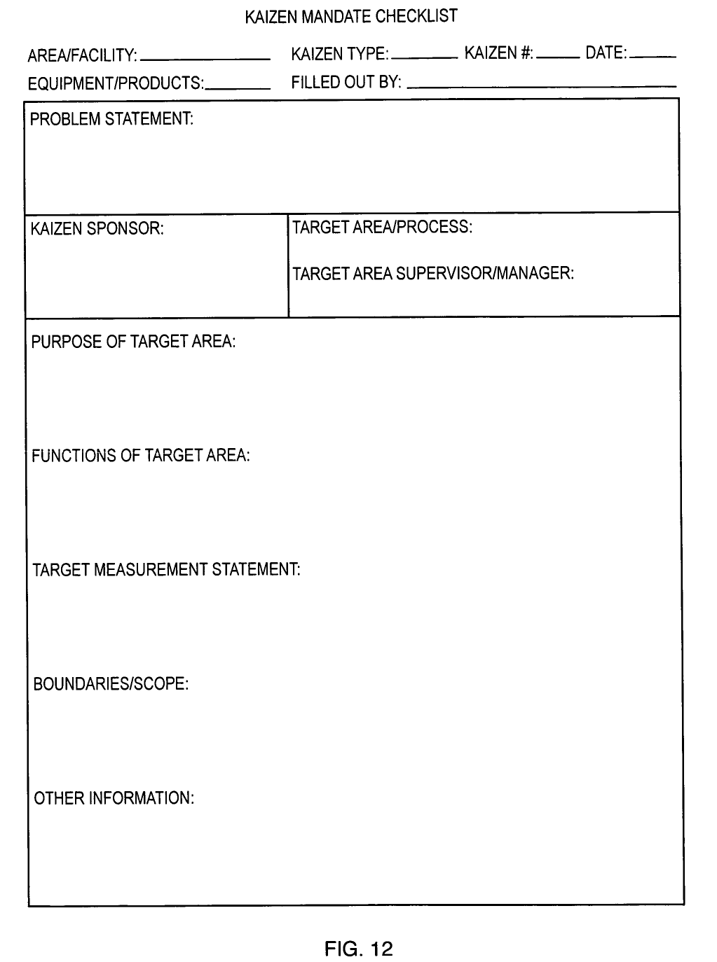

A final optional step in the method 200 of FIG. 3 is to implement, or aid in the implementation of, the steps outlined in the improvement worksheets through the planning function 50. There are various mechanisms and systems for producing tactical plans and implementing them once a business has identified the Outcomes of interest and desired plans for improving them. An example system for training businesses in improvement implementation is the TimeWise™ lean manufacturing program made available through the Manufacturing Extension Partnership of Augusta, Me. As part of that example system, FIGS. 11-12 illustrate one form of mechanism for implementing changes associated with the Outcomes deemed worthy of targeting for improvement. A Kaizen team composition chart such as that illustrated in FIG. 11, may be employed to define the person or persons considered helpful or responsible for implementing the task efforts represented in FIGS. 7-10 in a general way. A Kaizen mandate chart, such as that illustrated in FIG. 12, Further, FIG. 12, provides details of the improvement implementation that may be carried out pursuant to the TimeWise™ lean manufacturing program.

The steps of the method of the present invention, individually or in combination, may be implemented as a computer program product tangibly as computer-readable signals on a computer-readable medium, for example, a non-volatile recording medium, an integrated circuit memory element, or a combination thereof. Such computer program product may include computer-readable signals tangibly embodied on the computer-readable medium, where such signals define instructions, for example, as part of one or more programs that, as a result of being executed by a computer, instruct the computer to perform one or more processes or acts described herein, and/or various examples, variations and combinations thereof. Such instructions may be written in any of a plurality of programming languages, for example, Java, Visual Basic, C, or C++, Fortran, Pascal, Eiffel, Basic, COBOL, and the like, or any of a variety of combinations thereof. The computer-readable medium on which such instructions are stored may reside on one or more of the components of system 100 described above and may be distributed across one or more such components. Further, the steps of the method represented in FIG. 3, may be performed in alternative orders, in parallel and serially.

It is to be understood that various modifications may be made to the system 10 and related method without departing from the spirit and scope of the invention. Accordingly, other embodiments are within the scope of the claims appended hereto.

What is claimed is:

1. A method to enable a business to generate a representation of operations status and identify operations to improve, the method comprising the steps of:
a. identifying one or more groups of individuals associated with the business;
b. surveying each of the one or more groups for rankings and ratings values of one or more outcomes associated with the operation of the business;
c. normalizing the outcome rankings and ratings values for each of the one or more outcomes for each of the one or more groups;
d. calculating opportunity scores for each of the one or more outcomes;
e. associating a time value with each of the one or more outcomes; and
f. generating a visual representation of the opportunity scores for each of the one or more outcomes including an indication of those outcomes with relatively high opportunity scores signifying those outcomes as targets for improvement.

2. The method as claimed in claim 1 further comprising the step of generating a plan of effort to improve selectable ones of those of the one or more outcomes having relatively high opportunity scores.

3. The method as claimed in claim 1 further comprising the step of weighting the normalized outcome rankings and ratings values as a function of the identity of a particular group.

4. The method as claimed in claim 3 wherein one of the one or more identified groups comprises external customers and the normalized rankings and ratings values from the external customers group are doubled in value in comparison to the normalized rankings and ratings values of others of the one or more groups.

5. The method as claimed in claim 1 wherein the normalized rankings and ratings values are normalized through consensus building within each of the one or more groups.

6. The method as claimed in claim 1 wherein the time value is selected from the group consisting of Far Lagging, Lagging, Leading, and Far Leading.

7. The method as claimed in claim 1 where in the visual representation is an innovation dashboard table.

8. The method as claimed in claim 1 further comprising the step of creating one or more worksheets presenting steps to undertake to improve the opportunity scores for the one or more outcomes having relatively high opportunity scores.

9. The method as claimed in claim 8 wherein the one or more worksheets each includes an indication of an outcome, a planned behavior to improve the outcome, a measure to define the effect of the planned behavior, a stretch goal, and a data source.

10. A system enable a business to generate a representation of operations status and identify operations to improve, the system comprising:
a. a survey function for surveying one or more individuals of one or more identified groups to obtain ranking and rating values for one or more outcomes associated with the operation of the business;
b. a calculation function to calculate opportunity scores for the one or more outcomes based upon the ranking and rating values obtained from the survey function; and
c. a reporting function to provide a visual representation, with an associated time value, of the outcomes having relatively higher opportunity scores, indicating outcomes that may be improved to improve business status.

11. The system as claimed in claim 10 further comprising a planning function to generate a plan to improve the outcomes identified by the reporting function as having relatively higher opportunity scores.

12. The system as claimed in claim 11 wherein the planning function generates one or more worksheets presenting steps to undertake to improve the opportunity scores for the one or more outcomes having relatively high opportunity scores.

13. The system as claimed in claim 12 wherein the one or more worksheets each includes an indication of an outcome, a planned behavior to improve the outcome, a measure to define the effect of the planned behavior, a stretch goal, and a data source.

14. The system as claimed in claim 10 wherein the associated time values are selected from the group consisting of Far Lagging, Lagging, Leading, and Far Leading.

15. The system as claimed in claim 10 wherein the survey function is configured to normalize the outcome rankings and ratings established by the one or more groups.

16. The system as claimed in claim 15 wherein the outcome rankings and ratings are normalized by consensus within the group.

17. The system as claimed in claim 10 wherein the calculation function is configured to weight the outcome rankings and ratings from one group more heavily than others of the one or more groups.

18. The system as claimed in claim 10 wherein the visual representation is an innovation dashboard.

19. An apparatus to assist a business target and improve operational areas of weakness based on identified outcomes having importance to the operation of the business, the apparatus comprising a set of one or more worksheets configured to include a listing of one or more identified outcomes, steps to undertake to change the status of the one or more listed outcomes, one or more measures to measure the steps, one or more stretch goals, and one or more sources of information for the one or more measures.
